(19) United States
(12) Patent Application Publication
(10) Pub. No.: US 2005/0195861 A1
(43) Pub. Date: Sep. 8, 2005

(54) Sound communication system and mobile station

(75) Inventor: Susumu Kashiwase, Yokohama-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/064,670

(22) Filed: Feb. 23, 2005

(30) Foreign Application Priority Data
Feb. 27, 2004 (JP) 2004-053744

(51) Int. Cl. H04J 1/02

(52) U.S. Cl. 370/493

(57) ABSTRACT

A sound communication system in which sound information is transmitted and received via an internet protocol network, has a terminal of a transmission side having an encoding unit which encodes the sound information at a predetermined section of a frame unit, and a packetizing unit which packetizes the sound data of the frame unit which is encoded in the encoding unit while thinning out a predetermined frame, and a terminal of a reception side having a receiving unit which receives the encoded sound data which is packetized, and a decoding unit which decodes the encoded sound data which is received by the receiving unit while complementing the encoded sound data which is received at the predetermined frame unit.

### BACKGROUND OF THE INVENTION

1. Field of the Invention

The present invention relates to a sound communication system and to a mobile station which transmits and receives sound information via an internet protocol (IP) network.

Priority is claimed on Japanese Patent Application No. 2004-053744, filed Feb. 27, 2004, the content of which is incorporated herein by reference.

2. Description of Related Art

In wide-area wireless communication such as mobile wireless communication, which uses, for example, a mobile station, in the case of a high-speed packet communication system such as, in particular, an HRPD system or HSDPA system, the data speed of the downlink direction communication channel from a base station to the mobile station is high, and on the other hand, data speed of the uplink direction communication channel from the mobile station to the base station is low. In this case, it is assumed that voice-over-IP (VoIP) communication is performed. Because a velocity difference between the downlink direction communication channel and the uplink direction communication channel becomes a maximum of 10 or more times, transfer delay of the sound encoding packet of the uplink direction communication channel and the packet loss occur, and thereby a one-way calling state arises.

As an example of the conventional technology, there is communications standard 3GPP2-C.S0024 of the HRPD system. The method of deciding the transmission speed of the uplink direction communication channel in this standard is as follows (See C. S0024 Section 8.5.6.1.5.2).
(1) The uplink direction communication (the transmitting from the terminal to the base station) increases and decreases according to the activity bit which is shown from the base station (network).
(2) The terminal determines a transmitting rate using a probability.
1) If it is in the case in which the activity bit is 1 (the network is in the busy state), the transmitting rate is reduced by probability q.
2) If it is in the case in which the activity bit is 0 (the network is in the non-busy state), the transmitting rate is increased by probability p.
3) q and p are defined for every present transmitting rate. Because the transmitting rate is determined by only the present transmitting rate and the activity bit (having the correspondence table), there are problems in that the amount of the delay of the transmission is not reflected in the communication rate, and the communication rate is not reflected in the communication application. Therefore, the above-mentioned problems occur in VoIP applications.

An example of the sound communication system as the conventional technology (Non Patent Document 1: communication standard of an HRPD system 3GPP2-C.S0024 (http://www.3gpp2.org/Public_html/specs/index.cfm)) is explained.

In this sound communication system, HDR communication channel which performs high-speed packet communication apart from the communication channel which performs the sound communication is prepared. The purpose of this sound communication is that the sound communication is kept from being broken off by changing the sound communication channel and the data channel, while concentration of the traffic is avoided.

Here, HDR is a commercial name of the packet data communication system of HRPD system, and is the official name of the HRPD system which is registered at the ITU.

The purpose of the system described in Document 1 is that, in the case in which the traffic of the sound channel increases, the sound traffic is bypassed using the packet data channel such as the HRPD system or the like. However, when the sound is dataized and is transmitted as the packet data as it is, delay of the sound and pauses of the sound due to the packet delay occur. This fact is confirmed by a field test which was carried out in 2002.

That is, in VoIP communication, usually, sound encoding is frequently carried out using the sound encoding standard G729 (band 8 kbps) which is defined in ITU-T. In this case, if it is considered that an IP header is added to the information stream in VoIP communication, and the retransmitting margin is performed in a physical layer, the data speed thereof is set to about 20 kbps. Therefore, the data speed thereof becomes not less than 9.6 kbps which is a minimum speed step among the transmission speed of the upward communication channel of 1×EV-DO. As a result, the packet saves in the buffer during the communication in 9.6 kbps, and the delay in the sound transmission occurs. This state is shown in FIG. 4. FIG. 4 shows the relation ship between the upward transmission speed and time.

### SUMMARY OF THE INVENTION

The present invention was made in view of the above situation, and an object of the present invention is to provide a sound communication system and a mobile station in which delays in packets and pauses in calls are reduced in the case in which the sound communication of the mobile packet communication in which the communication speeds of the downlink direction communication channel and the uplink direction communication channel such as HRPD system differ extremely is performed.

In order to solve the above-described problems, the present invention is a sound communication system in which sound information is transmitted and received via an internet protocol network, having a terminal of a transmission side having an encoding unit which encodes the sound information at a predetermined section of a frame unit, and a packetizing unit which packetizes the sound data of the frame unit which is encoded in the encoding unit while thinning out a predetermined frame, and a terminal of a reception side having a receiving unit which receives the encoded sound data which is packetized, and a decoding unit which decodes the encoded sound data which is received by the receiving unit while complementing the encoded sound data which is received at the predetermined frame unit.

Moreover, the present invention provides a mobile station in which a sound information is transmitted and received via an internet protocol network, providing an encoding unit which encodes the sound information at a predetermined section of a frame unit, and a packetizing unit which packetizes the sound data of the frame unit which is encoded in the encoding unit while thinning out a predetermined frame.

Moreover, in the mobile station according to the present invention, the packetizing unit may thin out the frame which is restored in the mobile station at a decoding side in the case when it is missing.

Moreover, in the mobile station according to the present invention, the packetizing unit may thin out a frame every other frame.

Moreover, in the mobile station of the present invention, the encoding unit may encode the sound signal by CELP (Code Excited Linear Prediction) coding system.

Moreover, in the mobile station of the present invention, a communication speed of an upward direction may be variable.

Moreover, the present invention is a mobile station in which a sound information is transmitted and received via an internet protocol network, providing with a receiving unit which receives an encoded sound data which is packetized, and a decoding unit which decodes the encoded sound data which is received by the receiving unit while complementing the encoded sound data which is received at a predetermined frame unit.

Moreover, in the above constitution, the decoding unit may complement the encoded sound data in the frame immediately before on every other frame.

Moreover, in the mobile station of the present invention, the decoding unit may decode the encoded sound data by CELP (Code Excited Linear Prediction) coding system.

As explained above, according to the sound communication system and the mobile station due to the present invention, the sound communication system in which, in the case in which a sound call of the mobile packet communication is performed, delay of packets and pauses in calls are reduced is realized.

### BRIEF DESCRIPTION OF THE DRAWINGS

FIG. 1 is a view which shows a constitution of a sound communication system according to an embodiment of the present invention.

FIG. 2 is a block diagram which shows a constitution of a portable phone terminal according to the sound communication system shown in FIG. 1.

FIG. 3 is an explanatory diagram which shows the contents of processing in the case of performing VoIP communication between the portable phone terminal and internet protocol phone device in the sound communication system according to the embodiment of the present invention.

FIG. 4 is an explanatory diagram which shows the relation ship of an upward communication speed and time in VoIP communication.

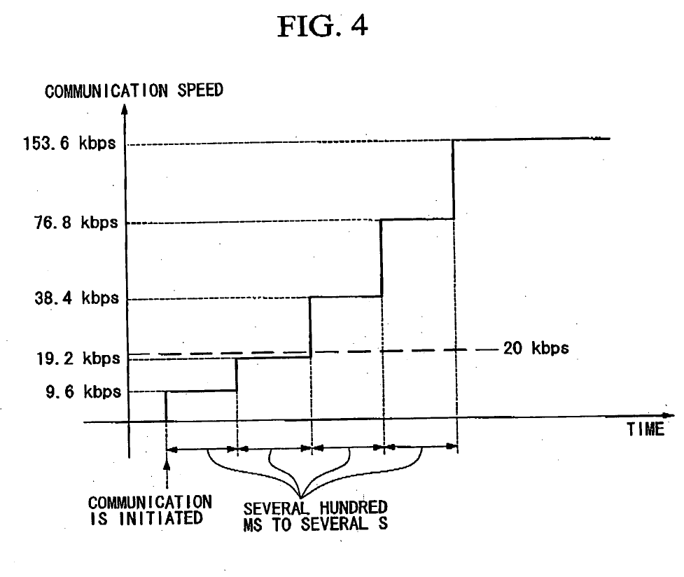

FIG. 5 is an explanatory diagram which shows a data flow of VoIP communication according to the sound communication system including a packet transmission channel by a wireless transmission.

### DETAILED DESCRIPTION OF THE INVENTION

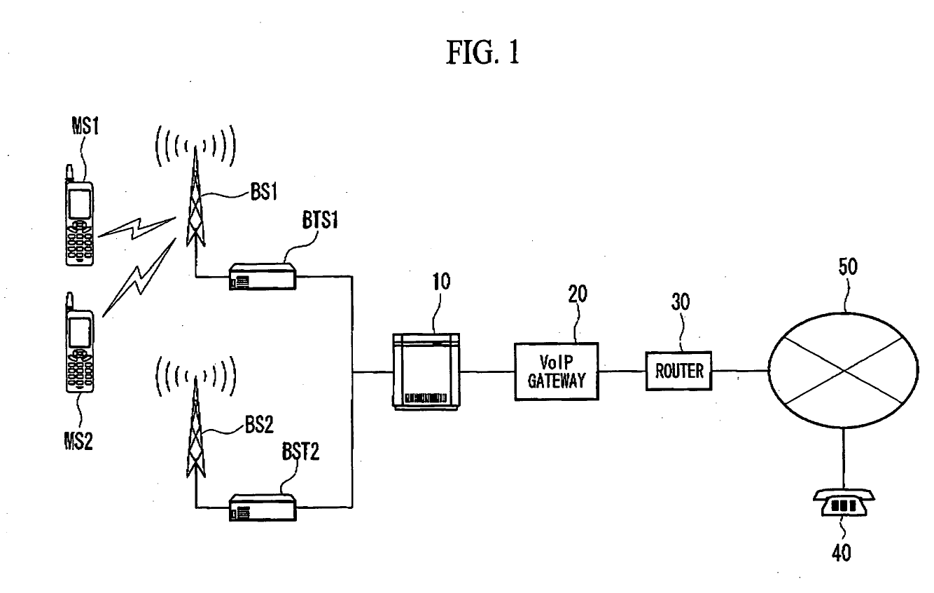

Hereinafter, an embodiment of the present invention is explained in detail with reference to the figures. The constitution of the sound communication system according to the embodiment of the present invention is shown in FIG. 1. In the present embodiment, an example of the portable phone terminal as a mobile station is explained. In this figure, the sound communication system according to the embodiment of the present invention is provided with a plurality of portable phone terminals MS1 and MS2, a plurality of base stations BS1 and BS2, base station devices BTS1 and BTS2, a control station 10 which is connected via a communication line, a VoIP gateway 20 which is connected to the control station 10, a router 30, an internet protocol (IP) network 50 which is connected to the router 30, and an IP phone device 40 which is connected to IP network 50.

In addition, actually, although a plurality of portable phone devices, a plurality of base stations, a plurality of base station devices, and a plurality of control stations exist, as a matter of convenience of the explanation, in the present embodiment, only MS1 and MS2 are shown as the portable phone terminal, only BTS1 and BTS2 are shown as the base station device, only 10 is shown as the control station.

A mobile communication network is constituted by a plurality of portable phone terminals MS1 and MS2, a plurality of base stations BS1 and BS2, a plurality of base station devices BTS1 and BTS2, and the control station 10 which is connected via the communication line.

The portable phone devices MS1 and MS2 have a phone function and a data transmission function. Furthermore, in order to perform VoIP communication, the portable phone terminal has the function of performing the sound encoding of the sound signal, packetizing the encoded sound signal, and transmitting the encoded sound signal which is packetized to the base stations BS1 and BS2.

The base stations BS1 and BS2 have a transmitting and receiving functions, and have the function which performs wireless connection control between the portable phone terminals within an area according to the connection demand from the portable phone terminal. Moreover, the base station devices BTS1 and BTS2 have the function of reconstructing the packet which is transmitted from each portable phone terminal for each portable phone terminal.

The control station 10 has the function of generally controlling a plurality of base stations.

The VoIP gateway 20 has the function of performing the IP packetizing of the packet which is received via the control station 10 in VoIP communication.

IP phone device 40 has the function of encoding the sound data which is inputted, packetizing the encoded sound data, and transmitting the encoded sound data which is packetized, and has the function of performing the sound decoding from the IP packet which is received, and transforming it to the sound signal of the analog signal.

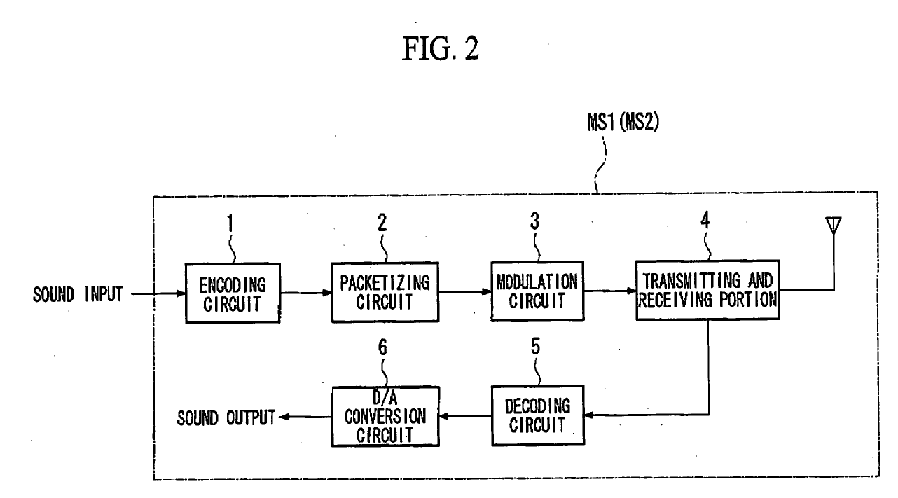

Next, the constitution of the portable phone device is shown in FIG. 2. Because the portable phone terminals MS1 and MS2 are the same constitutions, the portable phone device MS1 is explained. In this figure, the potable phone terminal MS1 is provided with an encoding circuit 1, a packetizing circuit 2, a modulation circuit 3, a transmitting and receiving portion 4, a decoding circuit 5, and a D/A conversion circuit 6.

The encoding circuit 1 encodes the sound signal at a predetermined section of a frame unit. In this case, for example, the sound signal is encoded by the CELP (Code Excited Linear Prediction) coding system. The encoding circuit 1 corresponds to the encoding unit in the present invention.

The packetizing circuit 2 packetizes several frames of sound data which is encoded in the encoding circuit 1. At this time, the packetizing circuit 2 packetizes the sound data while thinning out the encoded frames. In this case, for example, one frame is thinned out every other frame. Moreover, the packetizing circuit 2 thins out the frame which is restored in the potable phone terminal or the IP phone device 40 at the decoding side in the case it is missing. The packetizing circuit 2 corresponds to the packetizing unit of the present invention.

In addition, fundamentally, the IP phone device 40 is constituted including the functional portion equivalent to each circuit of the encoding circuit 1, the packetizing circuit 2, the decoding circuit 5, and D/A conversion circuit 6 in the portable phone terminal.

The modulation circuit 3 modulates the packet data by a predetermined modulation method.

The transmitting and receiving portion 4 transmits the packetized sound data and receives several frames of encoded sound data which is packetized.

The transmitting and receiving portion 4 corresponds to the receiving unit of the present invention.

The decoding circuit 5 decodes the encoded sound data which is received by the transmitting and receiving portion 4. At this time, the decoding circuit 5 complements the encoded sound data which is received at a predetermined frame unit, and decodes the encoded sound data which was complemented. Specifically, for example, the decoding unit decodes the sound data interpolating the encoded sound data of the adjacent frame. Thereby, the interpolated sound data is the constitution having the interpolated data every other frame. The decoding circuit 5 corresponds to the decoding unit of the present invention.

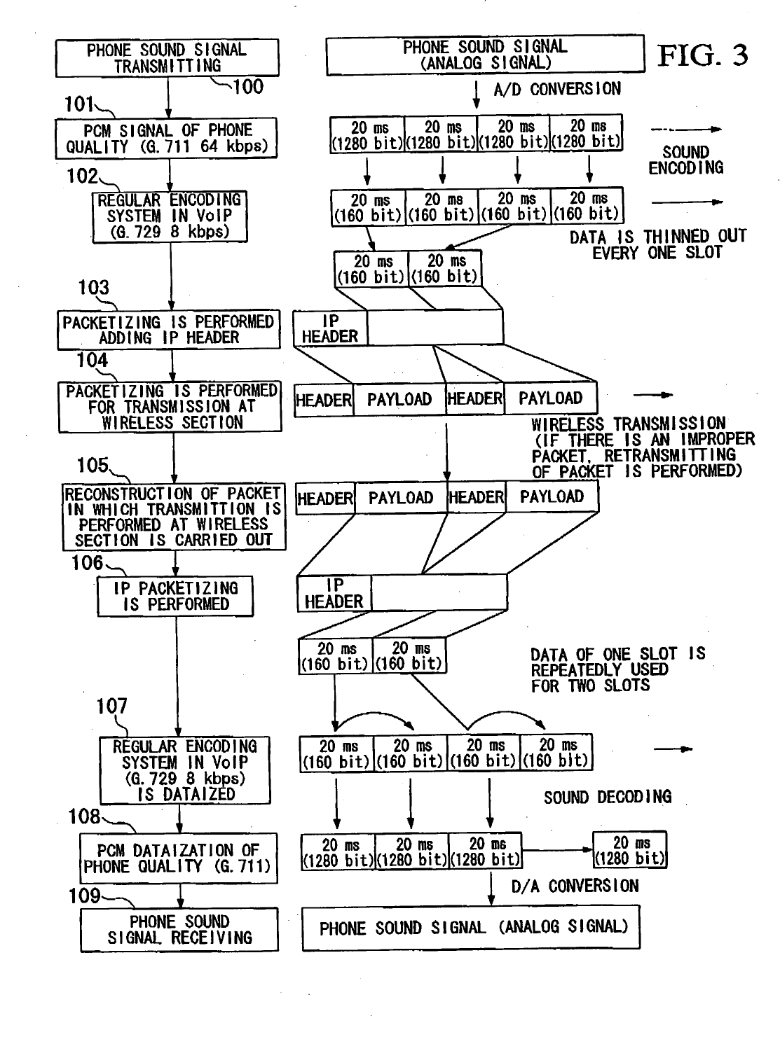

In the sound communication system according to the present embodiment which has the above-mentioned constitution, the processing in the case of performing VoIP communication between the portable phone terminal MS1 and the IP phone device 40 which is connected to IP network 50 is explained with reference to FIG. 3. In the sound communication system according to the present embodiment, in the case in which, because the communication speed control in the uplink direction communication channel is not proper, the communication speed in the uplink direction communication channel is low, the thinning out of the data and the complement processing of the data in which the quality of sound is sacrificed and the delay is decreased are performed.

In the above-mentioned constitution, the portable phone terminal MS1 initiates VoIP communication. That is, the transmitting of the phone sound signal (the analog signal) is initiated (Step 100). A/D conversion is performed for the phone sound signal thereof, and the digital signal thereof is transformed to PCM data every 20 ms by sound encoding standard G711 (band 64 kbps) and is frameized (Step 101).

The sound encoding is performed for the transformed PCM data by the sound encoding standard G729 (band 8 kbps) which is usually used by VoIP communication, and the thinning out of the data for every one slot is performed for the encoded data every 20 ms (Step 102).

Next, IP header is added to two slots of data, and IP packetizing is performed (Step 103). Furthermore, the header for carrying out wireless transmission of IP packet is added, and the transmitting for the base station BS1 is performed (Step 104).

The base station BS1 receives the packet from each portable phone terminal, and the base station device BTS1 reconstructs the received packet for every mobile station (Step 105). Furthermore, the VoIP gateway 20 performs the IP packetizing for the packet which is received from the portable phone terminal BS1 via the control station 10 by the base station BTS 1 (Step 106).

Next, IP phone device 40 performs the dataization for IP packet which is received from the VoIP gateway 20 via the router 30 and IP network 50 by the sound encoding standard G729 (band 8 kbps) which is usually used by VoIP communication, and the data of the thinned out slot complements the data of the adjacent frame (Step 107).

Furthermore, IP phone device performs the sound decoding (Step 108). That is, PCM dataization is performed for the data of each slot by the sound encoding standard GC711. Next, IP phone device 40 performs D/A conversion of PCM dataization, and acquires a phone sound signal (Step 109).

Thereby, a telephone call between the portable phone terminal MS1 and IP phone device 40 is initiated.

In addition, in the above-mentioned processing, it is possible for the section in which the data is thinned out and is interpolated to be set up for x seconds after the communication is initiated.

In the present embodiment, although the thinning out and the complement of the data is performed when the data rate is the minimum rate, after the data rate becomes not less than a predetermined rate, the thinning out and the complement of the data is stopped after a predetermined time goes on.

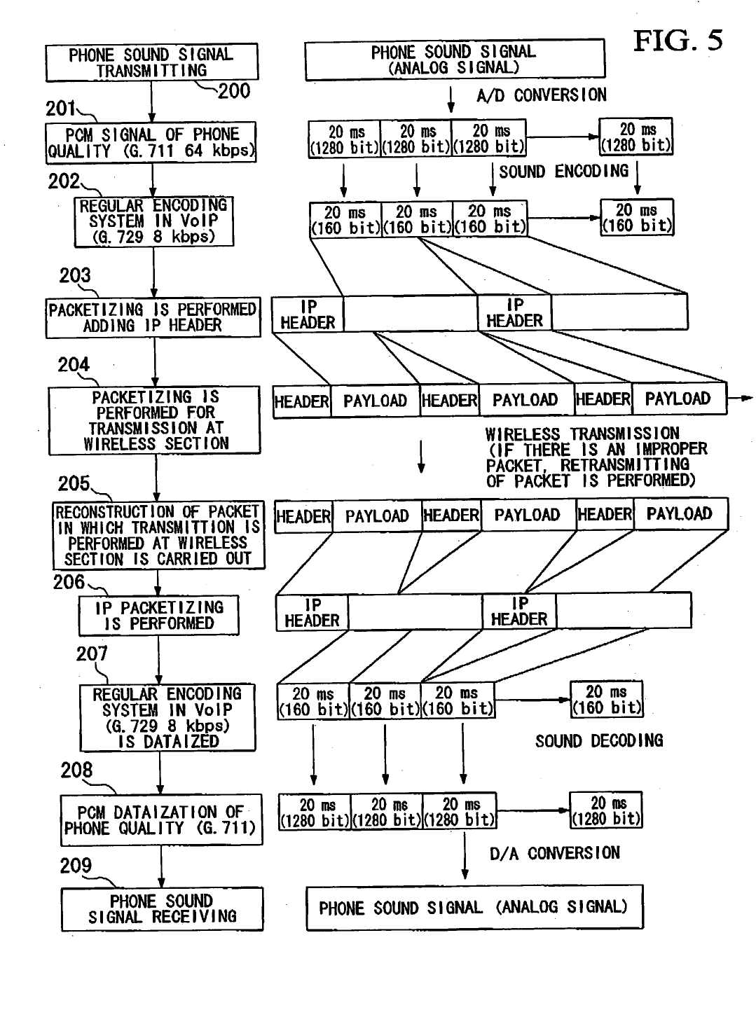

In addition, the data flow of VoIP communication in the sound communication system including the packet transmission channel due to the wireless transmission in which the data is not thinned out is shown in FIG. 5. Because the contents of FIG. 5 are included in the processing of FIG. 3, the explanation thereof is abbreviated.

According to the sound communication system of the present embodiment, the terminal of the transmission side is provided with an encoding unit which encodes the sound information at a predetermined section of a frame unit, and a packetizing unit which packetizes the sound data of the frame unit which is encoded in the encoding unit, in which the terminal of the reception side is provided with a receiving unit which receives the encoded sound data which is packetized, and a decoding unit which decodes the encoded sound data which is received by the receiving unit, and in which the packetizing unit packetizes the sound data while thinning out a predetermined frame, and the decoding unit complements the encoded sound data which is received at the predetermined frame unit, and decodes the encoded sound data for which the complement is performed, thereby delay of packets and pauses in calls can be reduced in the case in which the sound communication of the mobile packet communication in which the communication speeds of the downlink direction communication channel and the uplink direction communication channel extremely differ is performed.

The present invention is a mobile station in which a sound information is transmitted and received via an IP network, providing an encoding unit which encodes the sound information at a predetermined section of a frame unit, and a packetizing unit which packetizes the sound data of the frame unit which is encoded in the encoding unit, in which the packetizing unit packetizes the sound data while thinning out a predetermined frame.

Moreover, the present invention is a mobile station in which a sound information is transmitted and received via an IP network, provided with a receiving unit which receives several frames of encoded sound data which are packetized, and a decoding unit which decodes the encoded sound data which is received by the receiving unit, and in which the decoding unit complements the encoded sound data which is received at a predetermined frame unit, and decodes the encoded sound data for which the complement is performed.

Therefore, delay of packets and pauses in calls can be reduced in the case in which the sound communication of the mobile packet communication in which the communication speeds of the downlink direction communication channel and the uplink direction communication channel extremely differ is performed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A sound communication system wherein sound information is transmitted and received via an internet protocol network, comprising:
a terminal of a transmission side having an encoding unit which encodes the sound information at a predetermined section of a frame unit, and a packetizing unit which packetizes the sound data of the frame unit which is encoded in the encoding unit while thinning out a predetermined frame; and
a terminal of a reception side having a receiving unit which receives the encoded sound data which is packetized, and a decoding unit which decodes the encoded sound data which is received by the receiving unit while complementing the encoded sound data which is received at the predetermined frame unit.

2. A mobile station wherein a sound information is transmitted and received via an internet protocol network, comprising:
an encoding unit which encodes the sound information at a predetermined section of frame unit; and
a packetizing unit which packetizes the sound data of the frame unit which is encoded in the encoding unit while thinning out a predetermined frame.

3. The mobile station according to claim 2, wherein the packetizing unit thins out the frame which is restored in the mobile station at a decoding side in the case in which the frame is missing.

4. The mobile station according to claim 2, wherein the packetizing unit thins out a frame every other frame.

5. The mobile station according to claim 2, wherein the encoding unit encodes the sound data by a Code Excited Linear Prediction coding system.

6. The mobile station according to claim 2, wherein a communication speed of an upward direction is variable.

7. A mobile station wherein a sound information is transmitted and received via an internet protocol network, comprising:
a receiving unit which receives an encoded sound data which is packetized; and
a decoding unit which decodes the encoded sound data which is received by the receiving unit while complementing the encoded sound data which is received at a predetermined frame unit.

8. The mobile station according to claim 7, wherein the decoding unit complements the encoded sound data in the frame immediately before on every other frame.

9. The mobile station according to claim 7, wherein the decoding unit decodes the encoded sound data by a Code Excited Linear Prediction coding system.
